(19) United States
(12) Patent Application Publication
(10) Pub. No.: US 2024/0308141 A1
(43) Pub. Date: Sep. 19, 2024

(54) IDENTIFICATION OF OBJECTS

(71) Applicant: Hewlett-Packard Development Company, L.P., Spring, TX (US)

(72) Inventors: Sergio GONZALEZ MARTIN, Sant Cugat del Valles (ES); Ariadna MARIN CAMARA, Sant Cugat del Valles (ES); Jordi ROCA VILA, Sant Cugat del Valles (ES); Guiu TIO MEDINA, Sant Cugat del Valles (ES)

(21) Appl. No.: 18/268,556

(22) PCT Filed: Dec. 23, 2020
(86) PCT No.: PCT/US2020/066971

§ 371 Date: Jun. 20, 2023

(51) Int. Cl. B29C 64/393; B22F 10/60; B22F 10/85; B33Y 40/20; B33Y 50/02

(52) U.S. Cl. CPC B29C 64/393; B22F 10/60; B22F 10/85; B33Y 40/20; B33Y 50/02

(57) ABSTRACT

According to one example, there is provided a non-transitory computer-readable medium on which is stored computer-readable instructions that when executed by the computer cause the computer to obtain data relating to a set of objects generated by an object generation system, display using the obtained data a visualization of the set of objects, receive user input identifying a set of objects displayed in the visualization, supply, based on set of identified objects, obtained data, or data derived therefrom, to a post-processing module that is to process a set of objects corresponding to the set of identified objects.

### BACKGROUND

Three-dimensional printers are well known for being able to rapidly produce objects having a wide-range of geometries, in a wide-range of materials such as plastics, metals, and ceramics.

Objects generated by 3D printers may have to undergo some degree of post-processing before the object can be considered as a ‘final part’ that is suitable for use for its intended purpose. Post-processing operations include, for example: bead blasting, chemical polishing, dyeing, painting, and applying surface treatments or coatings.

### BRIEF DESCRIPTION

Examples will now be described, by way of non-limiting example only, with reference to the accompanying drawings, in which:

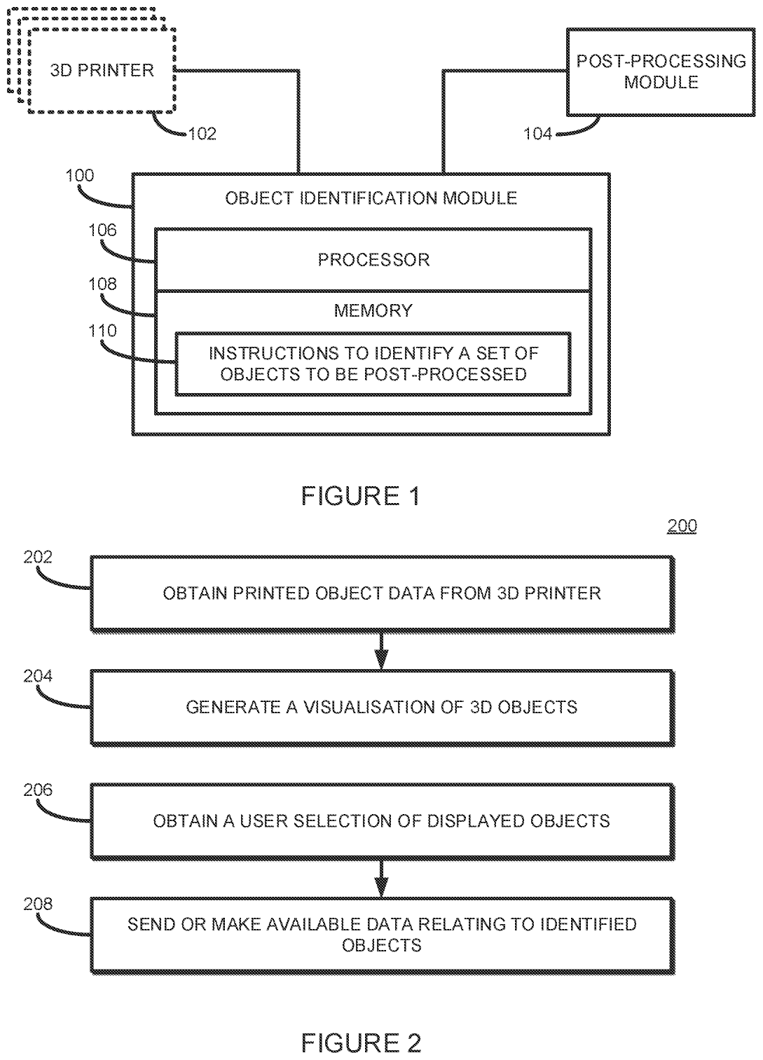

FIG. 1 is a schematic diagram of an object identification module according to an example;

FIG. 2 is a flow diagram outlining an example method of operating the object identification module according to an example;

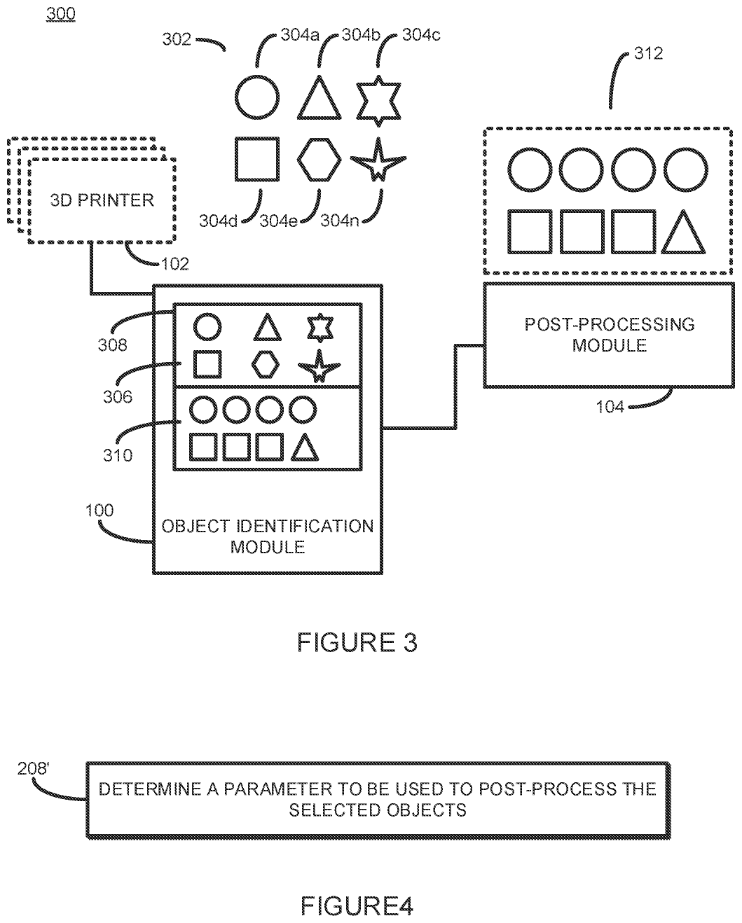

FIG. 3 is a schematic diagram of illustrating usage of an object identification module according to an example;

FIG. 4 is a is flow diagram outlining an example method of operating the object identification module according to an example.

### DETAILED DESCRIPTION

Many 3D printing systems are high-automated machines that generally require little more than provision of a suitable set of printer supplies and detailed object model data to generate objects. Depending on the type of 3D printer, printer supplies may include, for example, a supply of a powdered thermoplastic build material and a liquid fusing agent, a supply of a powdered metal build material and a liquid binder agent, and a supply of a photo-polymerizable liquid.

A 3D printing environment may comprise a one or multiple 3D printers that may each generate batches of objects for one or multiple different customers. Each object may have a desired final state that may require it to undergo one or multiple post-processing operations. For example, 3D objects generated using a powder-bed 3D printing technology, such as fusing agent-based systems or laser sintering systems, may have to be initially post-processed in a bead-blasting module to remove residual non-bound powdered build material from the object surface.

Depending on the desired final state of the object, for example depending on customer requirements, an object may then have to be chemically polished in a chemical polishing module to smooth the object surface, be dyed in a dyeing module, be painted in a painting module, have a surface coating applied in a coating module, etc. Different objects generated in a single batch by a 3D printer may thus take different post-processing paths depending on the type(s) or post-processing operation(s) to be performed thereon.

Once a 3D object is removed from a 3D printer subsequent tracking and identification of each 3D object becomes increasing complex, especially for objects to which no specific identification data is included, such as a serial number, a bar code, etc. This is especially the case in powder-bed 3D printing system where 3D objects may be generated at different horizontal and vertical positions in a build bed. As non-solidified build material is removed from a build bed, either manually or using an automated decaking process, at the end of a 3D printing process, the generated objects may become mixed up, may have their orientations changed, etc., further complicating identification of generated objects. This problem is further exasperated when manual handling of 3D printed objects is used, for example, to load objects into a post-processing module. Post-processing objects originating from large batches of 3D printed objects, and/or objects generated by different 3D printers further complicates matters.

Many post-processing modules have to have precise information about the objects which are to be post-processed before a post-processing operation can be performed. For example, a bead-blasting module may have to know the kind of blast media to be used, the blasting intensity to be used, and the blasting duration. A dyeing or a painting module may have to know parameters such as the color or colors different portions of an object are to be dyed or painted, a type of colorant to be used, a dye or colorant concentration, a quantity of colorant to be used, a process temperature, etc. Similarly, a chemical polishing module may have to know precise data relating to the geometry of each object in order to determine a suitable dose of polishing solvent to be used and/or a suitable process duration. These one or multiple parameters, which may be used to control a post-processing module, may be dependent on object characteristics, such as the material the object is made from and the object geometry.

Described herein are a method and a system to enable a post-processing module to determine details of objects to be processed thereby in a simple and efficient manner, thereby facilitating the determination of parameters of a post-processing module that is to process the objects.

Referring now to FIG. 1 there is shown a schematic diagram of an object identification module 100 that is connectable, for example via a suitable network or data link, to at least one 3D printer 102 or to any other suitable module such as a 3D printer job creation application, a 3D printing workflow management system, a database, a storage media, etc., that enables data relating to 3D objects generated by the 3D printer 102 to be obtained.

In FIG. 1 the object identification module 100 is shown as being connectable to a post-processing module 104, although in other examples the object identification module 100 may be integrated with a post-processing module.

The object identification module 100 comprises a processor 106, such as a microprocessor, a microcontroller, or the like, that is coupled to a memory 108. The memory 108 stores processor-readable instructions 110 that, when executed by the processor 106, provide an application that assists a user in identifying a set of 3D printed objects that are to be post-processed. When the instructions 110 are executed by the processor 106 they cause the method 200 shown in the flow diagram of FIG. 2 to be performed.

Example operation of the object identification module 100 will now be described in further detail with reference to the flow diagram of FIG. 2 and with additional reference to the schematic diagram of FIG. 3.

At block 202, the object identification module 100 obtains object data relating to a set 302 of 3D objects 304a, to 304n generated by the at least one 3D printer 102. In one example, the data obtained may relate to a set of objects generated by the at least one 3D printer 102 based on a set of criteria. In one example, a criterion may be objects generated within a predetermined time period. For example, the data may relate to objects 304 generated during the last hour, the last 2 hours, the last 6 hours, the last 12 hours, the last 24 hours, the last week, etc. In another example, a criterion may be objects generated for a particular customer, for example identified by a customer identifier. Other criterion may include, for example, the dimensions of the objects, a color of the objects, the material from the objects are generated.

The obtained data includes data describing the geometry of a 3D object that was generated, such as triangle mesh data, voxel data, etc., and may additionally include other data such as data describing a material from which a generated object was generated, data describing at least one dimension of a generated object, and data describing a color of at least one portion of a generated object. In one example the obtained data may be obtained from the 3D printer 102 from a print job file sent to the printer, for example sent from a pre-processing application or a computer aided design (CAD) application. In another example the 3D printer 102 may modify the data in a received print job file and may provide this modified data to the object identification module 100.

At block 204, the object identification module 100 uses the obtained data to generate a visualization, or graphical representation, 306 on a suitable user interface device 308, such as a display device, of the set of objects 302 generated by the 3D printer 102 based on the criteria. The selection criteria may, in one example, be input to the object identification module 100 by a user. In one example, the object identification module 100 displays only a single image of a generated object even if multiple copies of that object were included in the set of objects. The generated visualization may allow, for example, a user to scroll through images of the generated objects, may allow each object image to be displayed in a three-dimensional rendering and be rotated in three-dimensions by a user. In one example, each object may be displayed with accompanying dimensional information, such as a ruler or other dimensional measurements. In another example, each object may be displayed in substantially real size. In another example, each object may be displayed in color. Such features facilitate user identification of the objects on the display device 308.

Depending the nature of the data obtained from the 3D printer 102, the object identification module 100 may further process the obtained data prior to generating the visualization 306 of the set objects described therein. For example, the object identification module 100 may determine whether different objects within the set are effectively duplicated objects and may, in such a case, display only a single image of such objects. The object identification module 100 may also reduce the resolution or the complexity of the obtained data to allow the visualization to be displayed on the display device 306.

The aim of the object identification module 100 is to enable a user to identify within the object identification module 100 a set of objects generated by the 3D printer 102 that correspond to a set of generated objects that are to be processed in the post-processing module 104. Referring again to FIG. 3, a set of generated objects 312 selected by a user to be processed by the post-processing module are shown. As previously described, the post-processing module 104 has to have precise information about the objects which are to be post-processed before a post-processing operation can be performed.

The object identification module 100 thus comprises a suitable user interface to enable a user to identify a set of objects from the displayed visualization, for example using a touch-sensitive screen, a computer mouse, etc.

At block 206, the object identification module 100 obtains user input relating to the generated visualization 306. In this way, a user who has selected a set 312 of objects to be post-processed may use the generated visualization 306 and user interface to conveniently identify those objects. As shown in FIG. 3, as the user visually matches objects in the set 312 of objects to be post-processed with the set of objects displayed in the visualization 306, a further visualization 310 of the identified objects is also displayed on the display device 308. In addition to selecting an object shown in the visualization 306, a user may also select a number of times that object is included in the set of objects 312.

Once the object identification has been completed by the user, at block 208, the object identification module 100 sends or otherwise make available to the post-processing module 104 data relating to each of the identified objects to the post-processing module 104. In one example, the data sent or made available may be data as obtained from the 3D printer 102 as previously described. Such data may, for example, include object model data obtained from a print job file. In this example, the post-processing module 104 may process the data sent or made available to generate any suitable operating parameter to be used in controlling the post-processing module 104.

In another example, shown as block 208′ in FIG. 4 which replaces block 208 shown in FIG. 2, the data relating to each of the identified objects may be processed to generate or derive any suitable operating parameters to be used in controlling the post-processing module 104, and may send or make available to the post-processing module 104 one or multiple generated parameters. In another example, the object identification module 100 may directly control the post-processing module 104 using on the one or multiple generated parameters.

In one example the post-processing module 104 is a chemical polishing module. The one or multiple operating parameters may thus be derived from the obtained data, for example by calculating, for example, the external surface area of all the identified objects. Parameters of the post-processing module 104 may include, for example, a quantity of polishing solvent to be used, a type of polishing solvent to be used, and a time period during which the selected objects are to be exposed to a solvent. In other examples, the one or multiple operating parameters may be derived in any other suitable manner from the obtained data.

In another example, the post-processing module 104 is a bead-blasting module. In one example, in block 208, a generated operating parameter may include a fragility indicator based on the geometry of each object in the set of identified objects. The fragility indicator may indicate, for example, a degree of fragility of an object or a portion of an object. The fragility indicator may be used by a bead-blasting module to, for example, adjust a blasting intensity to be used, select a type of blast media to be used, determine a duration of a bead-blasting operation, etc. For example, for objects having a fragility indicator above a predetermined level (i.e. for relatively fragile objects) a soft blast media, such as crushed walnut shells may be chosen, whereas for objects having a fragility indicator below a predetermined level (i.e. for relatively non-fragile objects) a harder blast media such as sand may be chosen.

In another example, the object identification module 100 may communicate with multiple types of post-processing modules 104 and the one or multiple operating parameters may be adapted depending on the post-processing module type.

Although the examples described herein have referred to objects generated with a 3D printer, they are no way limited thereto. In other examples, however, the objects may be generated using other suitable types of object generation systems providing that they enable data relating to generated objects to be obtained. Such object generation systems may include, for example, suitable molding systems, subtractive manufacturing systems such computer numerical control (CNC) machining systems. In yet other examples the objects may include printed articles generated from two-dimensional printers. Such articles may include, for example, articles printed on print substrates such as paper, cardboard, wood, or the like. In such examples, a post-processing module may be any suitable post-processing module, that includes, for example: an object sorting module; an object packing module; an object varnishing module; an object coating module; and an object painting module.

As used herein, the term ‘post-processing’ is intended to cover any processing operation performed an object after its generation in an object generation system.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program. Still further, some examples may be conveyed electronically via any medium such as a communication signal carried over a wired or wireless connection.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of identifying a set of generated objects, comprising:
obtaining, from an object generation system, data relating to a set of objects previously generated thereby;
displaying, on a display device, a visual representation of the set of generated objects based on the obtained data;
receiving, via a user interface, a user input of a selection of the displayed objects, the user selection representing a set of objects generated by the object generation system to be post-processed in a post-processing module; and one of:
supplying obtained data relating to the user selected objects to the post-processing module;
supplying data derived from the obtained data relating to the user selected objects to the post-processing module; and
controlling a post-processing module using data derived from the obtained data relating to the user selected objects.

2. The method of claim 1, wherein obtaining data relating to a set of objects previously generated by an object generation system comprises at least one of obtaining data relating to objects generated: within a predetermined time period; having a predetermined identifier; having a predetermined dimension; having a predetermined color; and being generated from a predetermined material.

3. The method of claim 1, wherein the set of objects are generated by a three-dimensional printer and wherein obtaining data comprises obtaining data from a three-dimensional printer.

4. The method of claim 1, wherein displaying a visual representation comprises displaying at least one of:
a dimension of a generated object;
a material from which a generated object was generated; and
a color of a generated object.

5. The method of claim 1, wherein the post-processing module is a chemical polishing system, the method further comprising:
calculating, using the obtained data, the external surface area of the identified objects;
determining one or more of:
a quantity of a solvent to be used to post-process the identified objects;
a time period during which the identified objects are to be exposed to a solvent; and
a type of solvent to be used to post-process the identified objects.

6. The method of claim 1, wherein the post-processing system is a bead-blasting system, the method further comprising:
determining, using the obtained data, a fragility indicator based on the geometry of each object in the set of identified objects; and
determining one or more of:
a blasting intensity to be used to post-process the identified objects;
a type of blast media to be used to post-process the identified objects; and
a duration of a bead-blasting operation.

7. The method of claim 1, wherein the post-processing system is a dyeing or painting module, the method further comprising:
determining, using the obtained data, one or more of:
a type of colorant to be used;
a quantity of colorant to be used;
a concentration of colorant to be used;
a process temperature; and
a duration of a dyeing or painting process.

8. A non-transitory computer-readable medium on which is stored computer-readable instructions that when executed by the computer cause the computer to:
obtain data relating to a set of objects generated by an object generation system;
display using the obtained data a visualization of the set of objects;
receive user input identifying a set of objects displayed in the visualization; and
supply, based on set of identified objects, obtained data, or data derived therefrom, to a post-processing module that is to process a set of objects corresponding to the set of identified objects.

9. The non-transitory computer-readable medium of claim 8, wherein the computer-readable instructions are further to cause the computer to:
obtain one or more data relating to a set of objects generated by the object generation system:
within a predetermine time period;
having a predetermine customer identifier;
having a predetermined color;
generated using a predetermined build material; and
having a predetermined dimension.

10. The non-transitory computer-readable medium of claim 8, wherein the computer-readable instructions are further to cause the computer to obtain the data relating to a set objects generated by a three-dimensional printer.

11. The non-transitory computer-readable medium of claim 8, wherein the post-processing module is chemical polishing system, and wherein the computer-readable instructions are further to cause the computer to:
calculate the external surface area of the identified objects;
determine one or more of:
a type of solvent to be used by the chemical polishing system to chemically polish a set of objects corresponding to the identified objects;
a quantity of solvent to be used by the chemical polishing system to chemically polish a set of objects corresponding to the identified objects; and
a duration of a chemical polishing process to chemically polish a set of objects corresponding to the identified objects.

12. The non-transitory computer-readable medium of claim 8, wherein the post-processing module is a bead-blasting system, and wherein the computer-readable instructions are further to cause the computer to:
determine a fragility indicator based on the geometry of each of the identified objects; and
determining one or more of:
a blasting intensity to be used to post-process a set of objects corresponding to the identified objects;
a type of blast media to be used to post-process a set of objects corresponding to the identified objects; and
a duration of a bead-blasting operation.

13. The non-transitory computer-readable medium of claim 8, wherein the computer-readable instructions are further to cause the computer to display with each object at least one of: a dimension of a generated object; a material from which a generated object was generated; and a color of a generated object.

14. The non-transitory computer-readable medium of claim 8 integrated in a post-processing module.

15. An object identification module operable in accordance with claim 1.
